(19) United States
(12) Patent Application Publication
(10) Pub. No.: US 2010/0211353 A1
(43) Pub. Date: Aug. 19, 2010

(54) REGISTERING UNIT FOR RECORDING INPUT SIGNALS CAUSED BY MECHANICAL ACTION ON SAID UNIT, AND METHOD FOR RECORDING MEASURED VALUES AND PROCESSING SIGNALS

(75) Inventor: Oliver Völckers, Berlin (DE)

Correspondence Address: LONDA, BRUCE S.;NORRIS MCLAUGHLIN & MARCUS, PA, 875 THIRD AVE, 8TH FLOOR, NEW YORK, NY, 10022, US

(73) Assignee: TECH21 GMBH, Berlin (DE)

(21) Appl. No.: 12/666,943

(22) PCT Filed: Jun. 26, 2008
(86) PCT No.: PCT/EP08/05181

§ 371 Date: Apr. 28, 2010

(30) Foreign Application Priority Data
Jun. 29, 2007 (DE) 10 2007 030 356.6

(51) Int. Cl. G01B 7/14

(52) U.S. Cl. 702/158; 324/71.1

(57) ABSTRACT

The object of the invention of developing a three-dimensional flexible registering unit which can measure mechanical operations in the region at any desired positions over a defined length is achieved by virtue of the fact that said registering unit is in the form of a cable and comprises, in the three-dimensional extent, a flexible protective sleeve and two coaxially arranged conductor tracks, wherein one conductor track surrounds the other conductor track, and one of the conductor tracks is used as a measuring electrode and the other conductor track is in the form of an electrical resistor and has a voltage gradient, and a dielectric which electrically separates the two conductor tracks from one another in the quiescent state and enables punctiform or areal contact between the two conductor tracks when a mechanical force acts from the outside is situated between the two conductor tracks, and a measured value recording and evaluation unit which is suitable for determining a change in voltage or resistance triggered by operating the registering unit with a contact-pressure force vector is provided.

Registering unit for detecting input signals caused by mechanical impacts onto the registering unit and method for registration of the measured values and for signal processing.

The invention relates to a flexible registering unit of variable length and similar to a cable which can register applications of mechanical force on its entire length. Both the position and the size respectively the force of the actuation can be determined with a simple measuring hardware.

From prior art, systems are known where compressed air, gases or liquids in flexible tubes conduct a mechanical activation to a measuring system at one end of these tubes. However, such systems cannot determine the position of an activation. In addition, filled tubes are too heavy and vulnerable for small and mobile devices.

Other prior art includes light transmitting fibers, where a mechanical deformation changes the transmitted light (aberration, intensity). Such signal processing requires shielding the fibers against interfering light and a constant, energy-consuming light source.

Sensor cables as disclosed in U.S. Pat. No. 6,534,999 B2 are conventionally based on a piezo-electric layer, which converts the position and magnitude of mechanical agitations into electrical signals. Sensor cables according to U.S. Pat. No. 6,534,999 B2 are convenient for developing alarm systems, but they are neither designed nor suitable for finger operation. They do not deliver measured values when the contact pressure remains constant, do not register the contact area nor do they provide an interpretation of sequences of measured values over the course of the time of the activation. In addition, the piezoelectric layer of these sensor cables requires specific polymers.

Another convenient technology for detecting the position of touch are capacitive sensors. These are activated when bodies with a specific electrical capacity approach, e.g. with a soft touch of the finger, Activation with tools like a pen is therefore not possible, activation with fingers wearing gloves is problematic. Furthermore, capacitive sensor are still not available in flexible, bendable designs.

For measurement of the position and force of an activation, FSR (Force Sensing Resistors) foil sensors with flexible leads are a known technology. FSR can be designed as point-, strip- or area-sensors. A higher number of operating points requires a correspondingly higher number of conductive leads. Interpreting the sensor signals of FSR strips or areas affords complex interpretation electronics, preferably specialized chips. FSR membranes can be mounted to various three-dimensional shapes with flexible leads. However, the adaption must already be considered during construction and production. A subsequent mechanical deformation is not possible.

Beyond that, membrane switches are known. A number of membrane switches arranged in the form of a key matrix can determine the position of an activation. However, measuring the force of an activation is not possible.

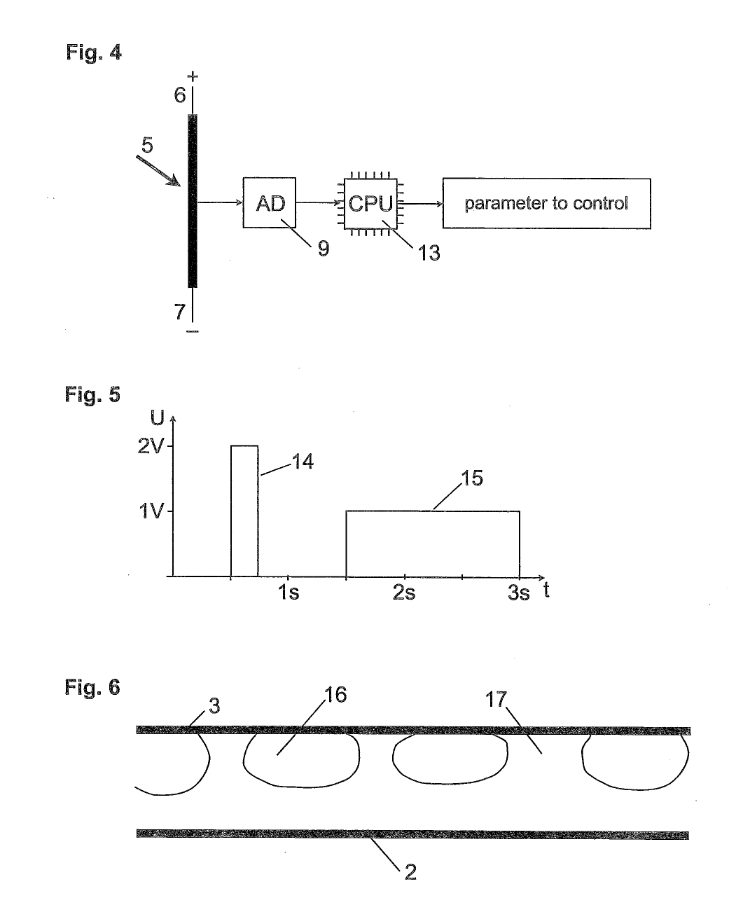

Instead of being arranged in a matrix, a plurality of membrane switches can also be linked with electrical resistances (prior art analog keypad technics, FIG. 4). A characteristic electrical resistance allows to determine the closed contact and its position. Measuring the force is also not possible with this.

With strain gauges, the force of an activation can be determined precisely, but not the position of the actuation.

Membrane potentiometers are another technology for registering the position and contact area of a touch. In their simplest form, they consist of a strip of bendable foil, which is partly coated with a material of high electrical resistance, a second foil, which is partly coated with a well conducting material and thirdly of an insulating spacer, which ensures that both coatings stay distant from one another in the resting state. When mechanical pressure is applied, the spacer allows a contact of the conductive coatings.

If foil potentiometers are deformed, their contact areas touch permanently so that they cannot register a mechanical activation any more. Therefore, foil potentiometers are not suitable for control elements which are integrated into cables and have to withstand more mechanical stress.

For this reason, control elements which are combined with cables are typically designed as separate units. Prior art remote controls, e.g. of music players or cell phones are integrated into headphone cables as separate housings with mechanical keys and/or a mechanical regulator. Lighting cables are often combined with a dimmer control for regulating the luminosity. In both cases, a separate unit with a special casing is needed.

The invention aims for low-cost manufacturing, a robust construction, a small size, low weight and especially for versatile usability.

The task is to develop a three-dimensional flexible registering unit, which can measure mechanical activations from a range of about 10 to 1000 grams at any position on a length from a few centimeters up to several meters.

This task is solved with the technical teaching disclosed in the patent claims:

FIG. 1: cross-section view of a registering unit according to the invention (resting state)

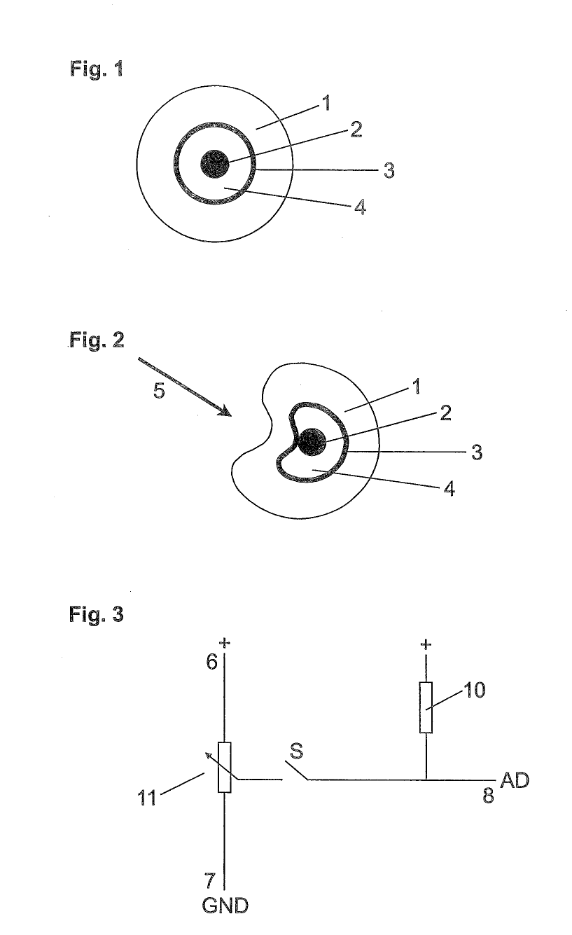

FIG. 2: cross-section view of a registering unit according to the invention (activated state)

FIG. 3: circuit diagram of a registering unit according to the invention

FIG. 4: signal processing diagram

FIG. 5: example of a pulse sequence caused by two punctiform actuations of a registering unit according to the invention and drawn along time axis t

FIG. 6: longitudinal section view of a drop-shaped coaxial dielectric (resting state)

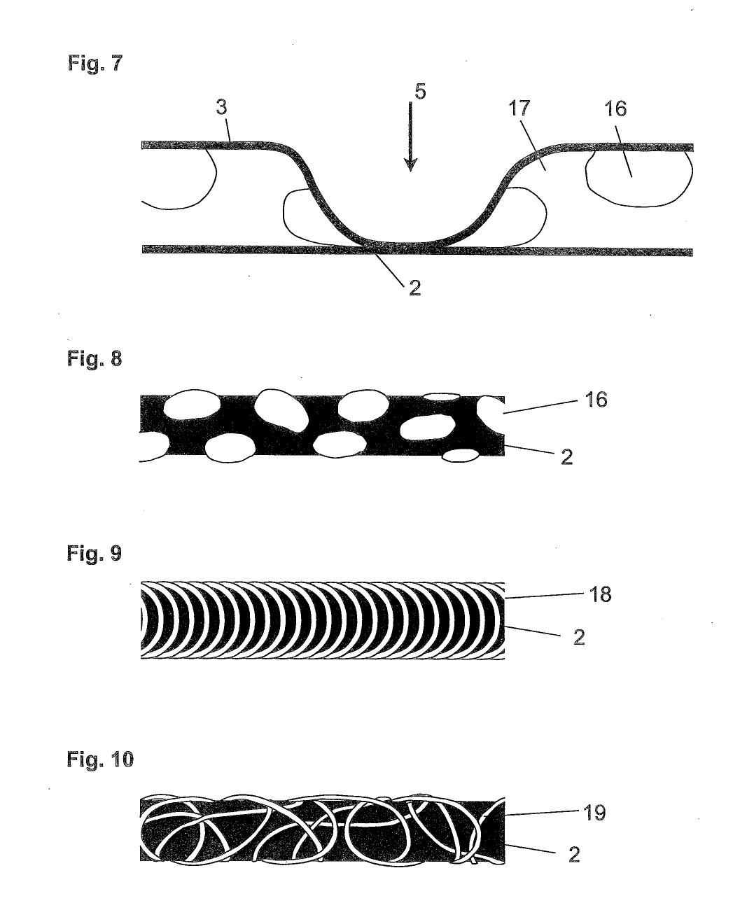

FIG. 7: longitudinal section view of a drop-shaped coaxial dielectric (activated state)

FIG. 8: drop-shaped coaxial flexible dielectric (lateral view with removed coaxial high-ohmic conductor)

FIG. 9: coaxial flexible dielectric shaped as repeated regular lines (lateral view with removed coaxial high-ohmic conductor path)

FIG. 10: coaxial flexible dielectric shaped repeated irregular lines (lateral view with removed coaxial high-ohmic conductor path)

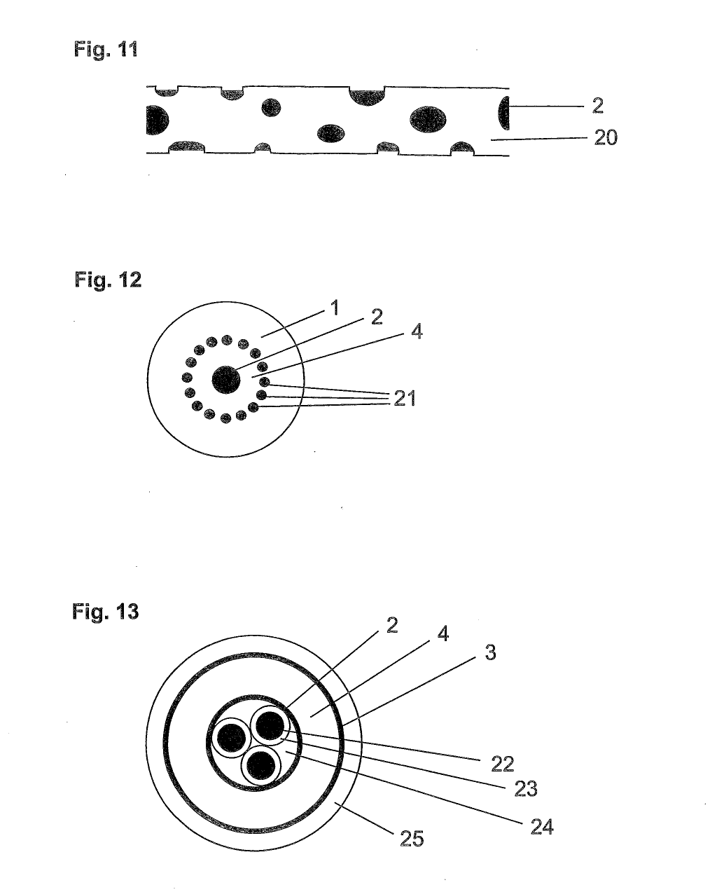

FIG. 11: coaxial flexible dielectric shaped as a cover with holes (lateral view with removed coaxial high-ohmic conductor path)

FIG. 12: Cross-section view of a registering unit according to the invention with a low-ohmic conductor which is divided into several conductors (resting state)

FIG. 13: Cross-section view of a registering unit according to the invention which is integrated into a three-wire cable (resting state)

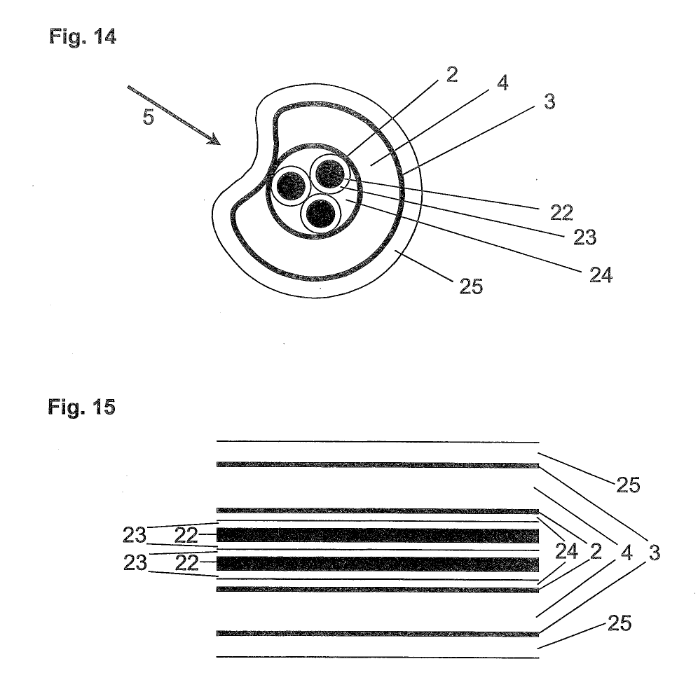

FIG. 14: cross-section view of a registering unit according to the invention which is integrated into a three-wire cable (activated state)

FIG. 15: longitudinal section view of a registering unit according to the invention which is integrated into a three-wire cable (resting state)

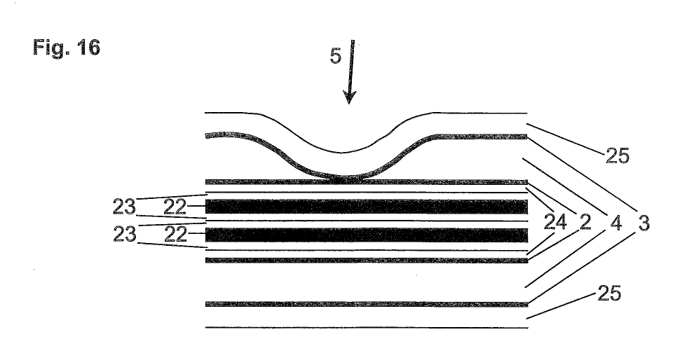

FIG. 16: longitudinal section view of a registering unit according to the invention which is integrated into a three-wire cable (activated state)

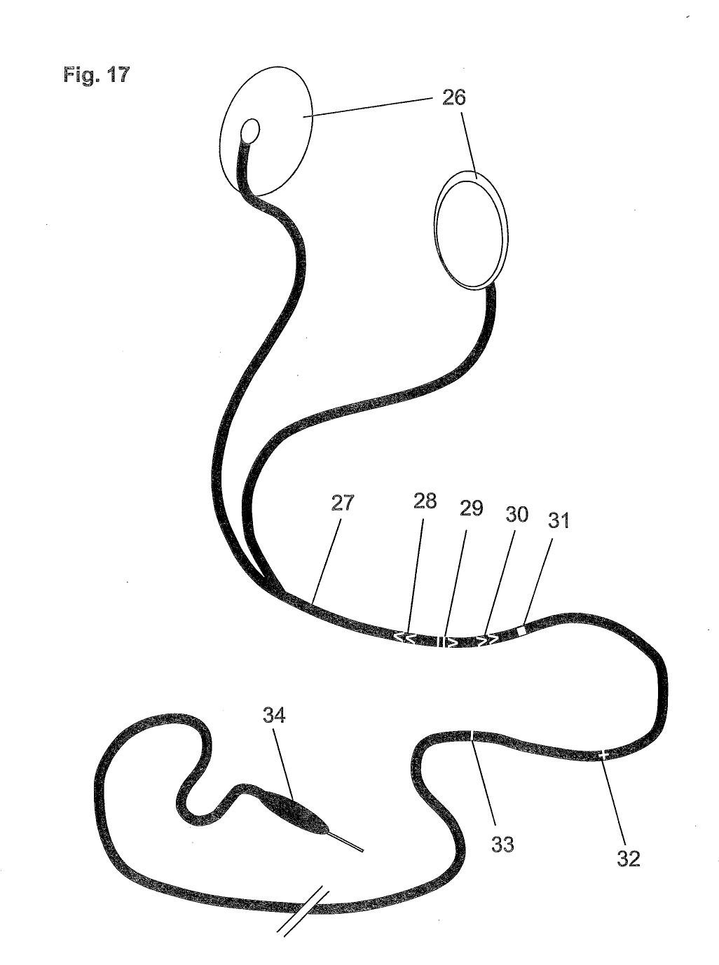

FIG. 17: an embodiment of a headphone cable with an integrated registering unit according to the invention as a remote control of a music player or cell phone

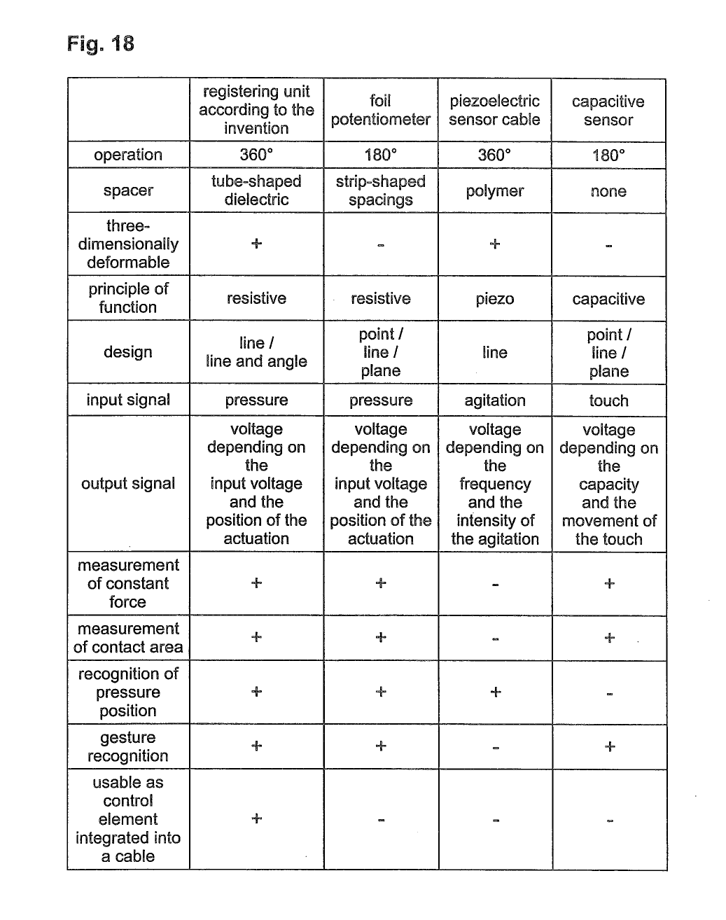

FIG. 18: comparison of sensor technologies, shown in a table.

FIG. 1 illustrates a cross section through a registering unit according to the invention in the resting state. The registering unit according to the invention comprises an outer protective covering 1, a low-ohmic conductor 2 in the center, a hereto coaxially arranged high-ohmic conductor 3 and a coaxial flexible dielectric 4, which provides a spacer between the conductors 2 and 3.

FIG. 2 shows a cross section through a registering unit according to the invention in an activated state, i.e. when the conductors 2 and 3 contact each other. This takes place when a blunt pressure with a force vector 5 is applied on the outer protective covering 1 of the cable-shaped registering unit. Due to the coaxial arrangement of the conductors 2 and 3 as well as of the dielectric 4, the invention allows for a contact anywhere on the cable-shaped registering unit.

In order to determine the trigger position, according to the invention a voltage gradient is generated in the circuit diagram of a registering unit as illustrated (FIG. 3) by connecting one end of the high-ohmic conductor 3 via an electrode 6 with a voltage and connecting the other end via an electrode 7 with ground. When the cable sensor is operated, the electrode 8 taps a voltage at the low-ohmic conductor 2 which is specific for each position of actuation. This voltage is measured with an A-D converter 9. The respective voltage towards the electrode 6 and towards the minus electrode 7 corresponds to the distances towards both ends of the cable sensor.

The contact area of the actuation with the force vector 5 cannot be determined by measuring the voltage alone. This is because with a significant contact area, the resulting voltage equals the average values of the voltages that would apply to tapping electrode 8 to the end points of the contact area.

The activation along a distance or at two points instead of one singular point causes a short circuit between these two points. This partial short circuit reduces the resistance between the electrodes 6 and 7 proportionally to the distance of these points. If desired, the contact area or length of an actuated distance can therefore be detected with electrical resistance measurement. The difference of the resistance between the electrodes 6 and 7 in the activated state and in the resting state then delivers the length of the actuated distance.

An example illustrates this: Let the electrical resistance between the electrodes 6 and 7 in FIG. 3 be 10 kilohms in the resting state. If the resistance decreases to 9 kilohms due to a partial short circuit, the section of the short circuit (=length of activation during operation) must be 1 kilohm. Since 1 kilohm is one tenth of 10 kilohms, 10% of the distance are connected.

In multiplex operation, an electronic circuit can toggle between both measurements rapidly, i.e. 10 to 500 times per second. In this way, the position of the actuation and the length of the activation can be registered almost simultaneously.

Alternatively, position and contact area of an actuation can also be determined by extending the electronic circuit of FIG. 3. For this purpose, the circuit is complemented with another pullup resistor 10, which is connected in series with the variable resistor 11 and is then located between the electrode 6 in FIG. 3 and variable resistor 11. The resistance of the pullup resistor 10 should be in the same range as the variable resistor 11. The voltage which is tapped between the pullup resistor 10 and the variable resistor 11 with a second A-D converter (not illustrated) is constant in the resting state, about half the input voltage. When the registering unit is operated, the voltage measured with the second A-D converter decreases proportionally to the contact area, while as described previously the position can be registered with the first A-D converter 9 of FIG. 3 at the same time. In an extreme case, i.e. with a very large contact area, the voltage at the second not illustrated A-D converter can decrease almost to zero.

FIG. 4 schematically shows an example of the signal process starting from the actuation of the registering unit according to the invention with a force vector 5. The measured values (voltage respectively electrical resistance) are processed with the interpreting electronics of the A-D converter 9 and passed on to the control unit 13 of the terminal device. Since the measured values can be associated unambiguously to the position of the activation respectively to the force of the pressure, the control unit 13 can determine if and which parameter (volume, speed, etc.) of the terminal device shall be changed or which function shall be executed.

FIG. 5 shows a pulse sequence along time axis t caused by two actuations at different positions of a flexible registering unit according to the invention. Both actuations are punctiform and follow one another. FIG. 5 shows that each position of actuation corresponds with a characteristic voltage. From the measured value, the interpreting electronics can determine the corresponding position of the actuation. FIG. 5 further shows that at constant pressure, the registering unit according to the invention provides a constant measured value during the complete time period of that actuation. The measured value 14 of 2 V results from a punctiform and during the time period of 250 milliseconds constant actuation. The measured value 15 of 1 V results from a punctiform and during the time period of 1.5 seconds constant actuation.

FIGS. 6 and 7 show the coaxially flexible dielectric 12 of a registering unit according to the invention in an enlarged longitudinal section view. It consists of a drop-shaped non-conductive material 16, which serves as a spacer between the conductors 2 and 3 of the registering unit according to the invention in the resting state (FIG. 6). As illustrated in FIG. 7, it is compressed and suppressed upon sufficient pressure, so that the conductors 2 and 3 touch each other at the position of the actuation.

FIG. 8 to FIG. 11 show possible variations of the flexible coaxial dielectric 4 in lateral view with removed coaxial high-ohmic conductor 3. FIG. 8 illustrates a dielectric shaped as drops 16. FIG. 9 shows a dielectric shaped as regular lines 18. FIG. 10 illustrates a dielectric shaped as irregular lines 19 and FIG. 11 shows a dielectric shaped as cover with holes 20.

FIG. 12 illustrates a variation of the registering unit according to the invention with the low-ohmic conductor 13 of FIG. 1 being divided into several conductors, which together form the conductor bundle 21. The single conductors are arranged coaxially and each of them is connected to a separate A-D converter (not illustrated). Depending on which and how many conductors of the conductor bundle 21 are actuated at which positions, the interpreting electronics can calculate not only the position of the actuation but also its orientation with respect to the entire circumference of 360°.

Using the example of a conventional three-wire power cable, FIG. 13 demonstrates that a registering unit according to the invention can be integrated into any desired power cable. A three-wire power cable usually comprises of three conductors 22, whereby one of the conductors 22 is connected to ground. Each conductor 22 is surrounded by an insulator 23. A filler material 24 is placed between the wires 22 and all wires 22 are collectively surrounded by a further insulator 25, the protective covering of the cable.

FIG. 14 shows a cross-section view of a registering unit according to the invention which is integrated into a three-wire power cable in the resting state. The registering unit according to the invention comprises of the following three layers which are arranged coaxially around the conductors 22 of the cable: a high-ohmic conductor 2 and a low-ohmic conductor 3, which are kept at a distance by the flexible dielectric 4 in the resting state.

FIG. 14 demonstrates how the conductors 2 and 3 touch each other due to an actuation with a force vector 5 onto a three-wire cable with an integrated registering unit according to the invention. It also shows that an electric contact is closed at the position of the applied pressure.

FIG. 15 illustrates a longitudinal section view of a registering unit according to the invention which is integrated into a three-wire cable in the resting state. The conductors 22 of the cable are coaxially surrounded by a high-ohmic conductor 3 and a low-ohmic conductor 2 beneath the exterior protective covering 1. In the resting state, the conductors 2 and 3 are kept at a distance by the flexible dielectric 4 which is also arranged coaxially.

FIG. 16 illustrates the way in which the conductors 2 and 3 touch each other via the flexible dielectric 4 due to an actuation with a force vector 5 onto a three-wire cable with a registering unit according to the invention. An electric contact is closed at the position of the applied pressure.

FIG. 17 shows an embodiment of the invention: a headphone cable 27 for a headphone 26, whereby a registering unit according to the invention is integrated into the cable 27 for remote control of a music player or cell phone. The labels 28, 29, 30, 31, 32, 33 are realized as visible imprints or tactile stampings. For further processing, the measured values are passed on to the interpreting electronics 34 via a connector plug 34.

When pressure is applied onto the headphone cable 27 between the labels 28 and 33, the value measured with the A-D converter is proportional to the distance between the contact point and the labels 28 and 33 respectively. The labels 28 to 31 on the cable 27 indicate positions on the registering unit according to the invention. The associated measured values are interpreted such that the rewind, play/pause, forward and stop function of the player are executed. The labels 33 and 32 on the headphone cable 27 indicate other positions on the registering unit according to the invention, where an actuation sets the minimum volume and the maximum volume respectively. If the user actuates any position on the headphone cable 27 between the labels 33 and 32, the A-D converter 9 measures the new signals according to the changed position.

A registering unit according to the invention can also be integrated into other cables in order to construct control elements, i.e. as dimmer control into lamp cables.

A registering unit according to the invention further allows for an integration of control elements for mobile electronic devices into clothes, i.e. jackets. Conventional switches require more cables and need to be either waterproof or easily detachable, which is costly. By contrast, a registering unit according to the invention may be pulled through hollows of textiles like a drawstring. If the clothes need to be washed or if the registering unit is damaged, it can easily be changed. Also, it is easy to equip clothes with an option to incorporate a registering unit according to the invention with almost no cost.

In FIG. 18, the registering unit according to the invention is compared with three different sensor technologies. The symbol “+” thereby stands for “yes” and “possible”, the symbol “−” for “not possible”. Only the present invention uses a cable-shaped flexible dielectric (4 in FIG. 1). Although the piezoelectric sensor is also flexibly deformable, it cannot determine the exact position of a constant actuation with the finger. Therefore, only the present invention allows to integrate a control element for electronic devices directly into a common low-voltage cable.

The advantages of the registering unit according to the invention first of all lie in its flexibility. It can be transported and sold like cables by the meter from reels. It can be divided and cut according to various requirements.

Machines, fixtures, bondings, packings and tools can be re-used from existing cable technology. This reduces cost and increases areas of application.

Since the registering unit according to the invention is flexibly deformable, it may be used in test set-ups and small batches, where a special construction of other sensors would not be economically feasible. This also applies for research, robotics, aids for challenged people, protheses and special machines.

The easily interpretable and stable signals allow to use low-cost and reliable electronics. Basically, one A-D converter is enough for a precise determination of the position of an actuation (accuracy about 0.1%, depending on the linearity of the high-ohmic conductor 3 in FIG. 1 and the resolution of the A-D converter 9). A second A-D converter is sufficient for roughly determining the level of pressure at the same time (between 20 g and 500 g with a precision of 20%, depending on the material of the envelope 1 in FIG. 1).

The low cost and robustness of the registering unit allows applications for instance in schools or in toys. Devices such as cell phones may obtain a control element which can easily be carried along.

### LIST OF REFERENCES

1: insulator as protective covering
2: low-ohmic coaxial conductor
3: high-ohmic coaxial conductor
4: dielectric
5: force vector
6: plus electrode
7: minus electrode
9: analog to digital converter
10: pullup resistor
11: signal detection element
13: control unit
14: measured value
15: measured value
16: drop-shaped flexible dielectric
17: opening in the flexible dielectric 4
18: flexible dielectric shaped as regular lines
19: dielectric shaped as irregular lines
20: flexible dielectric shaped as a cover with holes
21: low-ohmic conductor bundle
22: conductor
23: insulator surrounding each conductor 22 individually
24: stabilizing filler material between the conductors 22
25: insulator as protective covering
26: headphone
27: head phone cable with integrated registering unit according to the invention
28: label for rewind function
29: label for play/pause function
30: label for forward function
31: label for stop function
32: label for maximum volume
33: label for minimum volume
34: connection for terminal device

1. A registering unit, which is cable-shaped and on its entire three-dimensional extension comprises an outer flexible protective covering (1) and two conductors (2; 3) that are arranged coaxially to each other, wherein one conductor surrounds the other conductor on its entire length and one of the conductors serves as measuring electrode and the other conductor is designed as electrical resistance and has a voltage gradient; and a dielectric between the two conductors separates the two conductors (2; 3) from each other in the resting state and, when an external mechanical force is applied, allows for a punctiform or areal electrical contact between the two conductors (2; 3); and a measuring and interpreting unit determines a change of the voltage or electrical resistance due to an actuation of the registering unit with a force vector (5).

2. Registering unit according to claim 1, wherein the dielectric between the two conductors consists of insulating flexible and deformable solids with gas inclusions.

3. Registering unit according to claim 1, wherein the measuring and interpreting unit comprises an A-D converter (9) and a control unit (13).

4. Registering unit according to claim 1, wherein the low-ohmic conductor (3) comprises a conductor bundle (21) of separate conductors.

5. Registering unit according to claim 4, wherein the individual conductors of the conductor bundle are electrically insulated from one another and are independently connected to the measuring and interpreting unit.

6. Registering unit according to claim 1, wherein a power supply is provided that supplies one end of the high-ohmic conductor with a higher voltage and the other end with a lower voltage via an external cable.

7. Registering unit according to claim 1, wherein a power supply is provided that supplies one end of the high-ohmic conductor with a higher voltage and the other end with a lower voltage via at least one additional conductor in the centre of the registering unit.

8. Method for determining the position of the actuation of the registering unit, wherein the voltage at the low-ohmic conductor caused by a contact with the high-ohmic conductor (3) due to an actuation is measured.

9. Method for determining the length of the actuation of the registering unit, wherein the reduction of the resistance of the high-ohmic conductor (3) caused by a contact with the low-ohmic conductor due to an actuation is measured.
